(19) United States
(12) Patent Application Publication
(10) Pub. No.: US 2004/0107042 A1
(43) Pub. Date: Jun. 3, 2004

(54) Road hazard data collection system and method

(76) Inventor: Ryan E. Seick, Palatine, IL (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/310,004

(22) Filed: Dec. 3, 2002

(51) Int. Cl. G06F 19/00

(52) U.S. Cl. 701/117; 701/211

(57) ABSTRACT

A method of collecting a plurality of hazardous road condition data points (248, 348) includes providing a sensor (108) coupled to a vehicle (102), where the sensor functions to detect a hazardous road condition (110) in real-time. The hazardous road condition is recorded along with a location (250) associated with the hazardous road condition, where the road hazard and the location define a hazardous road condition data point (248, 348). The hazardous road condition data point (248, 348) is wirelessly transmitted to a road hazard database system (106), with the road hazard database system receiving a plurality hazardous road condition data points. The road hazard database system (106) then sorts and maps the plurality of hazardous road condition data points based on their corresponding location.

### BACKGROUND OF THE INVENTION

Road hazards, such as potholes, slippery surfaces, and the like are encountered in paved surfaces, such as roads, highways, driveways, parking lots and any paved surfaces which experience wear due to constant vehicular travel, temperature, weather, and the like. Currently, many vehicles provide route-planning guidance for vehicles to route around traffic obstacles such as accidents, construction, and the like. Generally, these vehicles use any of a variety of wireless communication devices in conjunction with a location service such as Global Positioning System (GPS), to locate the vehicle and the traffic obstacles. Also, current technology allows vehicles to monitor their routes, including time of travel, physical route, traffic, and the like, in real-time and report such information gathered to a central database where other vehicles can access and use this information for future route planning. However, a drawback of existing route planning systems is that road hazards are not tracked and reported so that a vehicle may avoid such road hazards.

Accordingly, there is a significant need for an apparatus and method that overcomes the disadvantages of the prior art outlined above.

### BRIEF DESCRIPTION OF THE DRAWINGS

Referring to the drawing:

FIG. 1 is a block diagram of a road hazard data collection system in accordance with an embodiment of the invention;

FIG. 2 is block diagram of a road hazard data collection system in accordance with another embodiment of the invention;

FIG. 3 is a block diagram of a road hazard data collection system in accordance with yet another embodiment of the invention;

FIG. 4 is a flow diagram in accordance with an embodiment of the invention; and

FIG. 5 is a flow diagram in accordance with another embodiment of the invention.

It will be appreciated that for simplicity and clarity of illustration, elements shown in the drawing have not necessarily been drawn to scale. For example, the dimensions of some of the elements are exaggerated relative to each other. Further, where considered appropriate, reference numerals have been repeated among the Figures to indicate corresponding elements.

### DESCRIPTION OF THE PREFERRED EMBODIMENTS

In the following detailed description of exemplary embodiments of the invention, reference is made to the accompanying drawings (where like numbers represent like elements), which illustrate specific exemplary embodiments in which the invention may be practiced. These embodiments are described in sufficient detail to enable those skilled in the art to practice the invention, but other embodiments may be utilized and logical, mechanical, electrical and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical, electrical, or logical contact. However, “coupled” may mean that two or more elements are not in direct contact with each other, but yet still co-operate or interact with each other.

For clarity of explanation, the embodiments of the present invention are presented, in part, as comprising individual functional blocks. The functions represented by these blocks may be provided through the use of either shared or dedicated hardware, including, but not limited to, hardware capable of executing software. The present invention is not limited to implementation by any particular set of elements, and the description herein is merely representational of one embodiment.

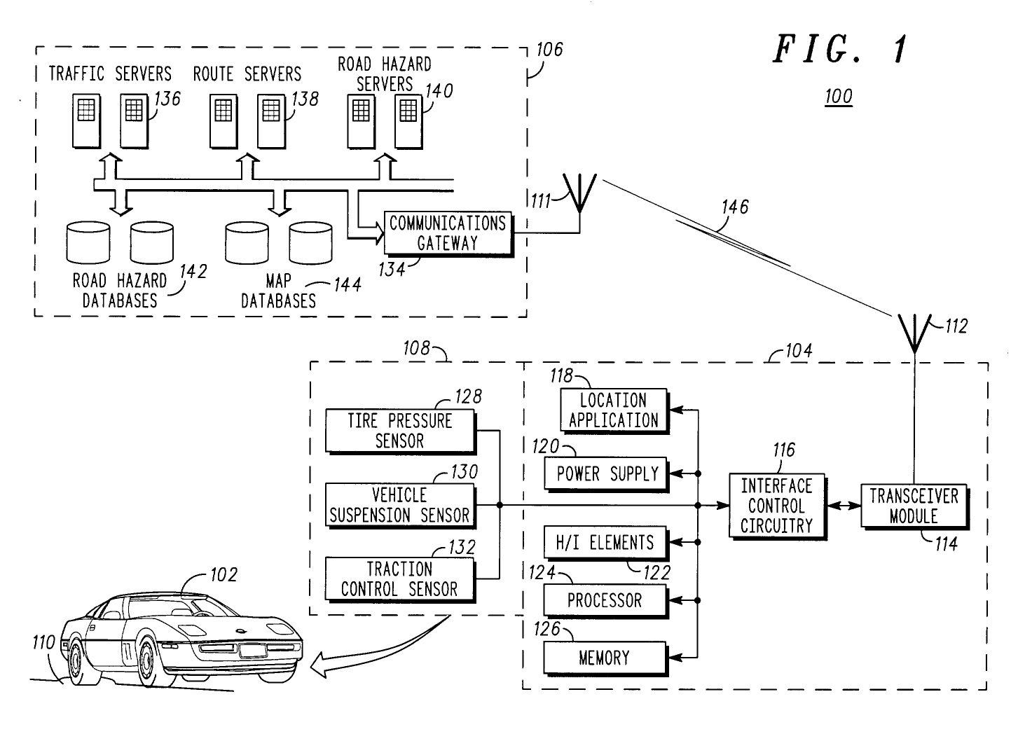

FIG. 1 is a block diagram of a road hazard data collection system 100 in accordance with an embodiment of the invention. As shown in FIG. 1, road hazard data collection system 100 includes a sensor 108 coupled to a vehicle 102. Also coupled to the vehicle 102 is road hazard avoidance unit 104, which can include, without limitation, a wireless unit such as a cellular or Personal Communication Service (PCS) telephone, a pager, a hand-held computing device such as a personal digital assistant (PDA) or Web appliance, telematics device, or any other type of communications and/or computing device. Without limitation, one or more road hazard avoidance units 104 can be contained within, and optionally form an integral part of vehicle 102, such as a car, truck, and the like. In an embodiment of the invention, a user can carry road hazard avoidance unit 104 and “plug it in” to a docking station in vehicle 102. Road hazard avoidance unit 104 is coupled to road hazard database system 106 via wireless link 146.

In an embodiment, road-hazard avoidance unit is connected to sensor 108 via a wireline connection, for example and without limitation, a dedicated wireline connection, the vehicle electrical bus, a separate bus, and the like. In another embodiment, road hazard avoidance unit 104 is connected to sensor 108 via a wireless link, and can communicate using protocols such as 802.11, Bluetooth, and the like.

Sensor 108 functions to detect a hazardous road condition 110 encountered by vehicle 102. In one embodiment, sensor 108 detects hazardous road condition 110 in real-time. Hazardous road condition 110 can include any driving condition (physical, environmental, and the like) hazardous to operation of vehicle 102. For example, and without limitation, hazardous road condition 110 can include potholes, slippery conditions such as ice, snow, and the like, obstacles in the road, and the like.

Sensor 108 can include any number of sensors on vehicle 102. For example, a tire pressure sensor 128 on one or more tires of vehicle 102 can detect a sudden increase in tire pressure, which can indicate a sudden impact with tire, such as when vehicle 102 hits a pothole or obstacle. As another example, vehicle suspension sensor 130 can detect and measure the severity of impact on the suspension of vehicle 102 (front and/or rear suspension), and also measure the depth of a pothole or the height of an obstruction encountered by vehicle 102. Yet another example of sensor includes traction control sensor 132, which can monitor and measure tire traction with the road and loss of traction due to a road hazard, such as icy conditions, oil slick, impact with a pothole or other obstruction. Tire pressure sensor 128, vehicle suspension sensor 130 and traction control sensor 132 are known in the art. The invention is not limited by the aforementioned types and numbers of sensors 108. Any number and type of sensor that detects hazardous road condition 110 are within the scope of the invention. For example, sensor 108 can also include an electro-optical device (including photo-electric surface detectors, video cameras, laser scanners, and the like) and be within the scope of the invention.

Sensor 108 detects hazardous road condition 110 with road hazard avoidance unit 104 monitoring sensor 108. When sensor 108 detects a hazardous road condition 110, sensor 108 sends a signal to road hazard avoidance unit 104 indicating where on vehicle 102 the hazardous road condition 110 is detected (for example, which tire, and the like). In an embodiment, sensors 108 can be located on each tire or portion of suspension and road hazard avoidance unit 104 can independently process signals from each sensor 108. In an embodiment, signals from sensor 108 can be averaged if only a portion of sensor 108 detects hazardous road condition 110. For example, if only one tire or portion of suspension detects hazardous road condition 110, while other sensors do not, road hazard avoidance unit 104 can average signals from all of the sensors 108. In another embodiment, road hazard avoidance unit 104 can record each instance of an encounter with hazardous road condition 110 independently regardless of what other sensors on vehicle 102 indicate. Road hazard avoidance unit 104 can tag each hazardous road condition 110 with a location and time stamp as discussed more fully below.

Road hazard avoidance unit 104 is powered by power supply 120 and includes an antenna 112, which feeds transceiver module 114 and interface control circuitry 116.

Transceiver module 114 is capable of sending and receiving content to and from road hazard database system 106 via wireless link 146. In an embodiment, wireless link 146 can include wireless communication taking place using a cellular network, paging network, satellite network, and the like. In an example of an embodiment, communication over wireless link 146 can include narrowband and/or broadband communications with standard cellular network protocols such as Global System for Mobile Communications (GSM), Time Division Multiple Access (TDMA), Code Division Multiple Access (CDMA), and the like. In another embodiment, standard transmission control protocol/internet protocol (TCP/IP) can also be used. In another embodiment, communication over wireless link 146 can include messaging protocols such Short Message Service Cell Broadcast (SMSCB), General Packet Radio Service (GPRS), and the like.

Road hazard avoidance unit 104 can include a processor 124 for processing algorithms stored in memory 126. Memory 126 comprises control algorithms, and can include, but is not limited to, random access memory (RAM), read only memory (ROM), flash memory, electrically erasable programmable ROM (EEPROM), and the like. Memory 126 can contain stored instructions, tables, data, and the like, to be utilized by processor 124.

Road hazard avoidance unit 104 can also include location application 118, which can include any number of position sources, devices and software elements designed to determine a location of road hazard avoidance unit 104, and vehicle 102. Examples of sources and devices, without limitation, include global positioning system (GPS), differential GPS, a kiosk (fixed position source), and enhanced observed time difference (EOTD), which comprise terrestrial cellular triangulation, and the like.

Road hazard avoidance unit 104 can include human interface (H/I) elements 122, which can comprise elements such as a display, a multi-position controller, one or more control knobs, one or more indicators such as bulbs or light emitting diodes (LEDs), one or more control buttons, one or more speakers, a microphone, and any other H/I elements required by road hazard avoidance unit 104. H/I elements 122 can request and display content and data including, application data, location data, personal data, email, audio/video, and the like. The invention is not limited by the (H/I) elements described above. As those skilled in the art will appreciate, the (H/I) elements outlined above are meant to be representative and to not reflect all possible (H/I) elements that may be employed.

In an embodiment, road hazard database system 106 can be a central database system designed to collect, sort and map road hazard information received from any number of sources, including vehicle 102. In an embodiment, road hazard database system 106 can function integrally with a cellular phone network, paging system, satellite communication network, telematics system, and the like. Road hazard database system 106 can communicate with road hazard avoidance unit 104 via antenna 111, which is coupled to communications gateway 134. Communications gateway 134 can comprise one or more network access devices (NAD's) that can utilize narrowband and/or broadband connections with standard cellular network protocols such as Global System for Mobile Communications (GSM), Time Division Multiple Access (TDMA), Code Division Multiple Access (CDMA), and the like. In another embodiment, standard transmission control protocol/internet protocol (TCP/IP) can also be used. In another embodiment, communications gateway 134 can include messaging protocols such Short Message Service Cell Broadcast (SMSCB), General Packet Radio Service (GPRS), and the like.

Road hazard database system 106 can include any number of servers and databases. Databases can include a hard drive, floppy disk drive, optical drive, CD-ROM, RAM, ROM, EEPROM, or any other means of storing content, which can be utilized by road hazard data collection system 100. By way of example, road hazard database system 106 can include traffic servers 136 and route servers 138 for processing data related to traffic such as traffic backups, delays, construction, and the like. Also included are road hazard servers 140 and road hazard databases 142, which can process and store data related to road hazards discussed more fully below.

Map databases 144 can function to store road maps for route calculation and transmission of routes between start locations and destination locations. Other databases (not shown) can function to store, among other things, user preferences in a user preference database, and the like. The servers and databases shown in FIG. 1 are exemplary and not to be limiting of the invention. Other servers and databases can be included in road hazard database system and are within the scope of the invention. Road hazard database system 106 can be coupled to a public switched telecommunication network (PSTN), Internet, an integrated services digital network (ISDN), satellites, local area networks (LAN's), wide area networks (WAN's) other communications systems (not shown for clarity), and the like.

Software blocks that perform embodiments of the invention are part of computer program modules comprising computer instructions, such as control algorithms, that are stored in a computer-readable medium such as memory described above. Computer instructions can instruct processors to perform methods of operating road hazard data collection system 100. In other embodiments, additional modules could be provided as needed. The components of road hazard data collection system 100 shown in FIG. 1 are not limiting, and other configurations and components that form road hazard data collection system 100 are within the scope of the invention.

FIG. 2 is block diagram of a road hazard data collection system 200 in accordance with another embodiment of the invention. As shown in FIG. 2, sensor 208 detects hazardous road condition 210 and transmits road hazard signal 203 to road hazard avoidance unit 204. Road hazard signal 203 can include the magnitude of impact of hazardous road condition 210 on vehicle 202, the depth or height of an obstruction, the amount and time of lost traction, and the like. Road hazard signal 203 can also indicate from which sensor 208 on vehicle 202 hazardous road condition 210 is detected.

In an embodiment, road hazard avoidance unit 204 records hazardous road condition 210 detected by sensor 208 along with location 250 where hazardous road condition 210 occurred. Location 250 can be obtained from location application 118 and include coordinates, for example, longitude, latitude, elevation, and the like. Hazardous road condition 210 detected by sensor 208 on vehicle 202 can be combined with location 250 to define hazardous road condition data point 248. In another embodiment, hazardous road condition data point 248 can further comprise a time stamp 252 to indicate, for example, the time of day, day of the week, and the like, in which hazardous road condition 210 is encountered.

In an embodiment, hazardous road condition data point 248 can be wirelessly transmitted to road hazard database system 206 using any network and wireless protocol, for example, those networks and wireless protocols described above. In one embodiment, hazardous road condition data point 248 is wirelessly transmitted to road hazard database system 206 in real-time. That is, as hazardous road condition 210 is detected and hazardous road condition data point 248 is created, hazardous road condition data point 248 is wirelessly transmitted to road hazard database system 206. In another embodiment, a plurality of hazardous road condition data points 248 are stored at road hazard avoidance unit 204 at vehicle 202 and wirelessly transmitted in a single communication session to road hazard database system 206. In this embodiment, plurality of hazardous road condition data points 248 can be stored at vehicle 202 until, for example, vehicle 202 is turned off, wireless transmission service is available or less expensive, and the like. This can be a more economical option because wireless service between vehicle 202 and road hazard database system 206 may not always be available when hazardous road condition 210 is encountered.

Upon receiving hazardous road condition data point 248, or a plurality of hazardous road condition data points 248 from one or more vehicles, road hazard database system 206 can compile and sort the plurality of hazardous road condition data points 248 based on their respective locations and/or time stamps. From this data, road hazard database system 206 can map each hazardous road condition 210 based on its corresponding location 250. From this mapping of hazardous road conditions 210, a database of road hazards and their respective locations can be created for further sale to local government agencies, mapping services, consumers/drivers, and the like. In another embodiment, road hazard database system 206 can map each hazardous road condition 210 based on its corresponding location 250 and its corresponding time stamp 252.

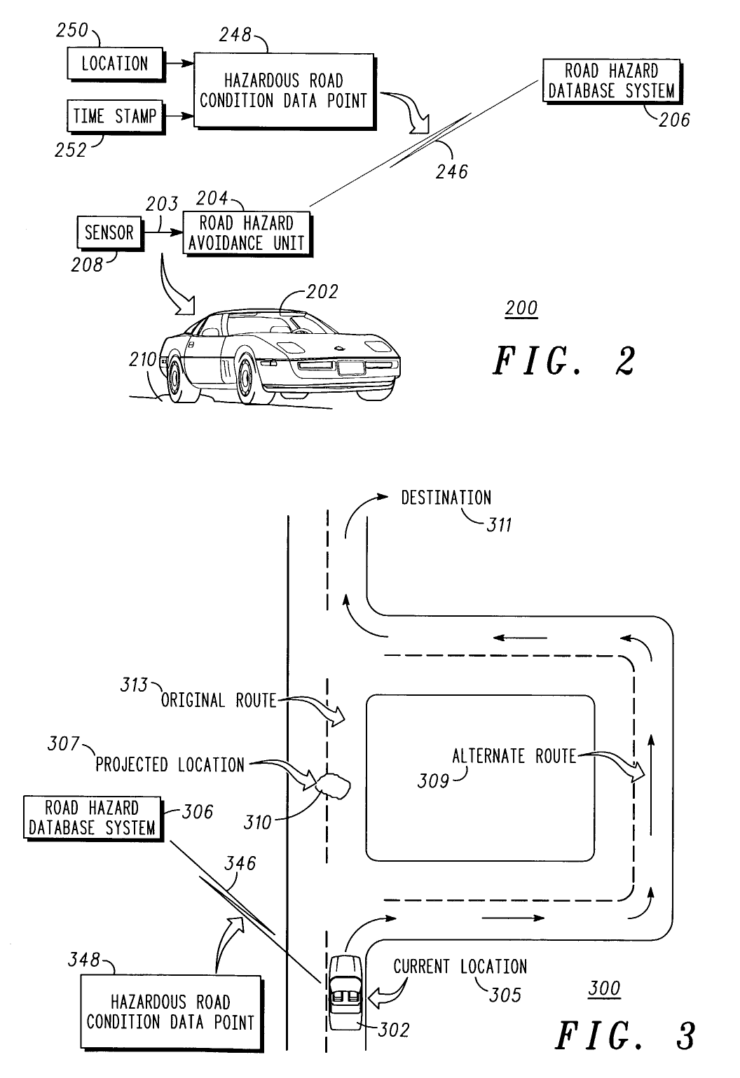

FIG. 3 is a block diagram of a road hazard data collection system 300 in accordance with yet another embodiment of the invention. As shown in FIG. 3, vehicle 302 can be en route to a destination 311, with the original route 313 between the current location 305 of vehicle 302 and destination 311 taking vehicle 302 through hazardous road condition 310. Based on current location 305 of vehicle 302, a projected location 307 of vehicle can be calculated based on the vehicle 302 speed, direction, roads available, and the like, where projected location 307 corresponds to hazardous road condition 310. In an embodiment, based on its corresponding location, hazardous road condition 310 has been earlier recorded and mapped into road hazard database system 306 by either vehicle 302 or another vehicle. Upon approaching projected location 307, road hazard database system 306 can be accessed to obtain at least one hazardous road condition data point 348 corresponding to projected location 307. Based on this, an alternate route 309 can be presented to bypass projected location 307 corresponding to hazardous road condition 310.

Alternate route 309 can be presented to driver of vehicle 302 by any means, for example, verbal instructions, visual instructions on a display, and the like.

In an embodiment, based on current location 305, road hazard avoidance unit 204 can wirelessly access road hazard database system 306 to obtain at least one hazardous road condition data point 348 corresponding to projected location 307. Based on the at least one hazardous road condition data point 348, road hazard avoidance unit 204 can calculate and present alternate route 309 to bypass projected location 307. In another embodiment, road hazard avoidance unit 204 can request at least one hazardous road condition data point 348 based on current location 305. In still another embodiment, road hazard database system 306 can notify road hazard avoidance unit 204 of at least one hazardous road condition data point 348 corresponding to projected location 307. In this embodiment, notification can occur with or without road hazard avoidance unit requesting such notification.

FIG. 4 is a flow diagram 400 in accordance with an embodiment of the invention. In step 402, sensor 108 is provided and coupled to vehicle 102, where sensor 108 is coupled to detect hazardous road condition 110. In step 404, hazardous road condition 110 is detected in real-time by sensor 108. In step 406, hazardous road condition is recorded along with location 250 to define hazardous road condition data point 248.

In step 408, hazardous road condition data point 248 is wirelessly transmitted to road hazard database system 106. In one embodiment, hazardous road condition data point 248 is transmitted in real-time. In another embodiment, a plurality of hazardous road condition data points 248 are stored at vehicle 102 and transmitted to road hazard database system 106 in one communication session. Subsequently, road hazard database system 306 receives plurality of hazardous road condition data points 248 per step 410.. In step 412, plurality of hazardous road condition data points 248 are compiled and sorted based on each of their corresponding locations. In step 414, road hazard database system 106 maps plurality of hazardous road condition data points 248 by location 250. This can be done for subsequent use in notifying the government agencies of a hazardous road condition and/or notifying a driver of an upcoming hazardous road condition and giving them a chance to avoid it.

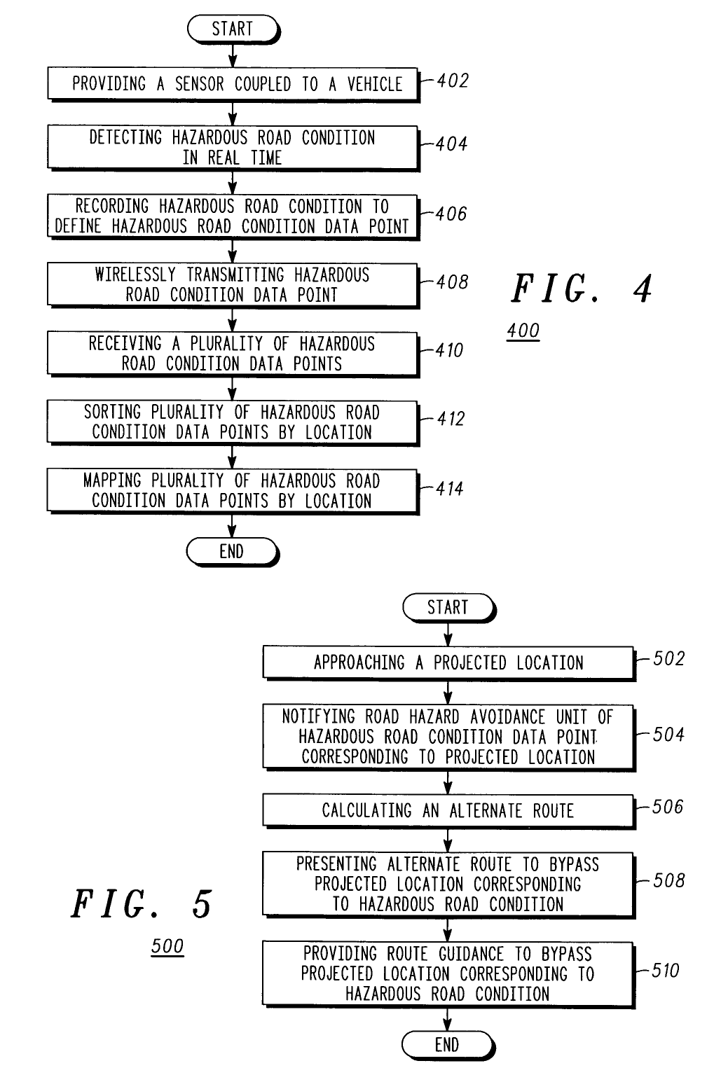

FIG. 5 is a flow diagram 500 in accordance with another embodiment of the invention. In step 502, vehicle 102 can approach a projected location 307, where projected location 307 corresponds to hazardous road condition 310. In this embodiment, based on projected location 307, hazardous road condition 310 has been earlier recorded and mapped into road hazard database system 306 by either vehicle 302 or another vehicle.

In step 504, road hazard avoidance unit 104 is notified of hazardous road condition data point 248 corresponding to projected location 307. In this embodiment, notification can occur after road hazard avoidance unit 104 has requested notification, or notification can occur when vehicle approaches projected location 307. As an example of an embodiment, notification can be triggered based on the speed and direction of vehicle 302 and vehicle 302 entering a specified distance between current location 305 and projected location 307.

In step 506, an alternate route 309 is calculated to avoid hazardous road condition 310. In an embodiment, alternate route 309 can be calculated by road hazard avoidance unit 104 and presented to a driver of vehicle 102. In another embodiment, alternate route 309 can be calculated by road hazard database system 306 and wirelessly transmitted to vehicle over wireless link 146. In step 508, alternate route is presented to bypass projected location 307 corresponding to hazardous road condition 310 with route guidance being provided per step 510. Alternate route 309 can be presented to driver of vehicle 302 and guidance provided by any means, for example, verbal instructions, visual instructions on a display, and the like.

While we have shown and described specific embodiments of the present invention, further modifications and improvements will occur to those skilled in the art. It is therefore to be understood that appended claims are intended to cover all such modifications and changes as fall within the true spirit and scope of the invention.

1. A method of reporting a hazardous road condition, comprising:
providing a sensor coupled to a vehicle, wherein the sensor functions to detect the hazardous road condition;
detecting the hazardous road condition in real-time;
recording the hazardous road condition along with a location associated with the hazardous road condition, wherein the hazardous road condition and the location define a hazardous road condition data point;
wirelessly transmitting the hazardous road condition data point to a road hazard database system;
upon subsequently approaching a projected location corresponding to the location, accessing the road hazard database system to obtain at least one hazardous road condition data point corresponding to the projected location; and
presenting an alternate route to bypass the projected location corresponding to the hazardous road condition.

2. The method of claim 1, wherein the sensor comprises at least one of a tire pressure sensor, a vehicle suspension sensor and a traction control sensor.

3. The method of claim 1, wherein the hazardous road condition data point comprises a time stamp.

4. The method of claim 1, wherein wirelessly transmitting comprises wirelessly transmitting the hazardous road condition data point in real-time.

5. The method of claim 1, further comprising storing a plurality of hazardous road condition data points at the vehicle, and wherein the plurality of hazardous road condition data points are wirelessly transmitted in a single communication session to the road hazard database system.

6. A method of mapping a hazardous road condition, comprising:
providing a sensor coupled to a vehicle, wherein the sensor functions to detect the hazardous road condition;
detecting the hazardous road condition in real-time;
recording the hazardous road condition along with a location associated with the hazardous road condition, wherein the hazardous road condition and the location define a hazardous road condition data point;
wirelessly transmitting the hazardous road condition data point to a road hazard database system;
the road hazard database system receiving a plurality hazardous road condition data points; and
mapping the plurality of hazardous road condition data points based on the location.

7. The method of claim 6, further comprising:
upon subsequently approaching a projected location corresponding to the location, accessing the road hazard database system to obtain at least one hazardous road condition data point corresponding to the projected location; and
presenting an alternate route to bypass the projected location corresponding to the hazardous road condition.

8. The method claim 6, wherein the sensor comprises at least one of a tire pressure sensor, a vehicle suspension sensor and a traction control sensor.

9. The method of claim 6, wherein the hazardous road condition data point comprises a time stamp.

10. The method of claim 6, wherein wirelessly transmitting comprises wirelessly transmitting the hazardous road condition data point in real-time.

11. The method of claim 6, further comprising storing the plurality of hazardous road condition data points at the vehicle, and wherein the plurality of hazardous road condition data points are wirelessly transmitted in a single communication session to the road hazard database system.

12. A road hazard data collection system, comprising:
a sensor coupled to a vehicle, wherein the sensor functions to detect a hazardous road condition in real-time;
a location application coupled to the vehicle, wherein the location application provides a location corresponding to the hazardous road condition to define a hazardous road condition data point; and
a road hazard database system coupled to wireless receive a plurality of road condition data points, and wherein the road hazard database system maps the plurality of hazardous road condition data points based on the location.

13. The road hazard data collection system of claim 12, further comprising a road hazard avoidance unit coupled to the vehicle, wherein based on a current location of the vehicle the road hazard avoidance unit accesses the road hazard database system to obtain at least one hazardous road condition data point corresponding to a projected location, and wherein the road hazard avoidance unit presents an alternate route to bypass the projected location.

14. The road hazard data collection system of claim 13, wherein the road hazard avoidance unit requests the at least one hazardous road condition data point based on the current location.

15. The road hazard data collection system of claim 13, wherein based on the current location the road hazard database system notifies the road hazard avoidance unit of the at least one hazardous road condition data point corresponding to the projected location.

16. The road hazard data collection system of claim 12, wherein the hazardous road condition data point comprises a time stamp.

17. A vehicle, comprising:
a sensor coupled to the vehicle, wherein the sensor functions to detect a hazardous road condition in real-time;
a location application coupled to provide a location corresponding to the hazardous road condition to define a hazardous road condition data point; and
a communication means coupled to wirelessly transmit the hazardous road condition data point to a road hazard database system.

18. The vehicle of claim 17, further comprising a road hazard avoidance unit coupled to the vehicle, wherein based on a current location of the vehicle the road hazard avoidance unit accesses the road hazard database system to obtain at least one hazardous road condition data point corresponding to a projected location, and wherein the road hazard avoidance unit presents an alternate route to bypass the projected location.

19. The vehicle of claim 18, wherein the road hazard avoidance unit requests the at least one hazardous road condition data point based on the current location.

20. The vehicle of claim 18, wherein based on the current location the road hazard database system notifies the road hazard avoidance unit of the at least one hazardous road condition data point corresponding to the projected location.

21. The vehicle of claim 17, wherein the hazardous road condition data point comprises a time stamp.

22. The vehicle of claim 17, wherein the communication means wirelessly transmits the hazardous road condition data point in real-time.

23. A method of compiling a plurality of hazardous road condition data points, comprising:
providing a sensor coupled to a vehicle, wherein the sensor functions to detect a hazardous road condition;
detecting the hazardous road condition in real-time;
recording the hazardous road condition along with a location associated with the hazardous road condition, wherein the hazardous road condition and the location define a hazardous road condition data point;
wirelessly transmitting the hazardous road condition data point to a road hazard database system;
the road hazard database system receiving the plurality hazardous road condition data points; and
sorting the plurality of hazardous road condition data points based on the location.

24. The method of claim 23, further comprising:
upon subsequently approaching a projected location corresponding to the location, accessing the road hazard database system to obtain at least one hazardous road condition data point corresponding to the projected location; and
presenting an alternate route to bypass the projected location corresponding to the hazardous road condition.

25. The method claim 23, wherein the sensor comprises at least one of a tire pressure sensor, a vehicle suspension sensor and a traction control sensor.

26. The method of claim 23, wherein the hazardous road condition data point comprises a time stamp.

27. The method of claim 23, wherein wirelessly transmitting comprises wirelessly transmitting the hazardous road condition data point in real-time.

28. The method of claim 23, further comprising storing the plurality of hazardous road condition data points at the vehicle, and wherein the plurality of hazardous road condition data points are wirelessly transmitted in a single communication session to the road hazard database system.

29. A computer-readable medium containing computer instructions for instructing a processor to perform a method of compiling a plurality of hazardous road condition data points, the instructions comprising:
providing a sensor coupled to a vehicle, wherein the sensor functions to detect the hazardous road condition;
detecting the hazardous road condition in real-time;
recording the hazardous road condition along with a location associated with the hazardous road condition, wherein the hazardous road condition and the location define a hazardous road condition data point;
wirelessly transmitting the hazardous road condition data point to a road hazard database system;
the road hazard database system receiving the plurality hazardous road condition data points; and
sorting the plurality of hazardous road condition data points based on the location.

30. The computer-readable medium of claim 29, further comprising:
upon subsequently approaching a projected location corresponding to the location, accessing the road hazard database system to obtain at least one hazardous road condition data point corresponding to the projected location; and
presenting an alternate route to bypass the projected location corresponding to the hazardous road condition.

31. The computer-readable medium claim 29, wherein the sensor comprises at least one of a tire pressure sensor, a vehicle suspension sensor and a traction control sensor.

32. The computer-readable medium of claim 29, wherein the hazardous road condition data point comprises a time stamp.

33. The computer-readable medium of claim 29, wherein wirelessly transmitting comprises wirelessly transmitting the hazardous road condition data point in real-time.

34. The computer-readable medium of claim 29, further comprising storing the plurality of hazardous road condition data points at the vehicle, and wherein the plurality of hazardous road condition data points are wirelessly transmitted in a single communication session to the road hazard database system.
